(19) United States
(12) Patent Application Publication
(10) Pub. No.: US 2006/0084329 A1
(43) Pub. Date: Apr. 20, 2006

(54) Connection terminal structure of wiring board

(75) Inventor: Shinji Murata, Fukushima-ken (JP)

Correspondence Address: BRINKS HOFER GILSON & LIONE, P.O. BOX 10395, CHICAGO, IL, 60610, US

(73) Assignee: ALPS ELECTRIC CO., LTD.

(21) Appl. No.: 11/252,295

(22) Filed: Oct. 14, 2005

(30) Foreign Application Priority Data
Oct. 19, 2004 (JP) 2004-303908

(51) Int. Cl. H01R 4/02

(52) U.S. Cl. 439/876

(57) ABSTRACT

A connection terminal structure of a wiring board according to the invention includes a second terminal area portion that is made of a metallic material having poor solder wettability and is formed on a first terminal area portion, and a third terminal area portion for soldering-connection that is made of a noble metal having excellent solder wettability and is formed on the second terminal area portion. Accordingly, since the third terminal area portion for soldering-connection, made of a noble metal, is formed on the second terminal area portion, which is an unsoldering surface, the third terminal area portion firmly adheres to the second terminal area portion serving as an unsoldering surface. Therefore, the third terminal area portion is not peeled off, and the third terminal area portion made of a noble metal has excellent solderability. For this reason, since preliminary soldering is not required, it is possible to obtain a connection terminal structure of a wiring board having excellent productivity.

### BACKGROUND OF THE INVENTION

1. Field of the Invention

The present invention is related to a connection terminal structure of a wiring board suitable for various electronic circuit units.

2. Description of the Related Art

FIG. 4 is an enlarged cross-sectional view showing main parts of a connection terminal structure of an electronic component according to the related art. The connection terminal structure of the electronic component according to the related art will be described below with reference to FIG. 4. An electrode 52 made of a metallic material is provided on a side of one end of a rod-shaped electronic component 51, and a metal layer 53 made of chrome, which is unsolderable, is provided on the surface of the electrode 52 to form an unsoldering surface.

A metal layer 54 made of copper or nickel, which is solderable, is provided on the surface of the metal layer 53 so as to form a soldering surface, and a soldering film 55 is formed on a surface of the metal layer 54 by dipping in a soldering bath so as to form the connection terminal structure of the electronic component in the related art (for example, JP-A-11-251177).

However, in the connection terminal structure of the electronic component in the related art, since the metal layer 54, serving as a soldering surface, is made of copper or nickel, the metal layer 54 does not firmly adhere to the metal layer 53 serving as an unsoldering surface. For this reason, the metal layer 54 is peelable. Accordingly, a soldering film should be preliminarily formed to improve the solderability, which causes low productivity.

In the connection terminal structure of the electronic component according to the related art, since the metal layer 54, serving as a soldering surface, is made of copper or nickel, the metal layer 54 does not firmly adhere to the metal layer 53 serving as an unsoldering surface, which causes the metal layer 54 to be peeled off. In addition, a soldering film should be preliminarily formed to improve the solderability, which results in a low degree of productivity.

### SUMMARY OF THE INVENTION

It is an object of the invention to provide a connection terminal structure of a wiring board in which a terminal area portion for soldering-connection is not peelable and which has high productivity.

In order to achieve the object, according to an aspect of the invention, a connection terminal structure of a wiring board includes a wiring board, a wiring pattern that is formed on the wiring board to have a first terminal area portion, a second terminal area portion that is made of a metallic material having poor solder wettability and is formed on the first terminal area portion, and a third terminal area portion for soldering-connection that is made of a noble metal having excellent solder wettability and is formed on the second terminal area portion. The third terminal area portion has a smaller area than the second terminal area portion so that the second terminal area portion forming an unsoldering surface exists on the outer circumference of the third terminal area portion.

In addition, in the above-mentioned structure, it is preferable that the third terminal area portion be made of gold, silver, or an alloy having these materials as main ingredients.

Furthermore, in the above-mentioned structure, it is preferable that the second terminal area portion be made of nickel, chrome, titanium, tantalum, or an alloy having these materials as main ingredients.

Further, in the above-mentioned structure, it is preferable that the wiring board be made of epoxy resin, ceramic, or alumina, and that the first and second terminal area portions be formed on the wiring board in the form of a thick or thin film.

### BRIEF DESCRIPTION OF THE DRAWINGS

FIG. 1 is an enlarged plan view showing main parts of a connection terminal structure of a wiring board according to the invention;

FIG. 2 is an enlarged cross-sectional view showing the main parts of the connection terminal structure of the wiring board according to the invention;

FIG. 3 is an enlarged cross-sectional view showing a state in which an electronic component is connected to a connection terminal of the connection terminal structure of the wiring board according to the invention; and

FIG. 4 is an enlarged cross-sectional view showing main parts of a connection terminal structure of an electronic component in the related art.

### DESCRIPTION OF THE PREFERRED EMBODIMENTS

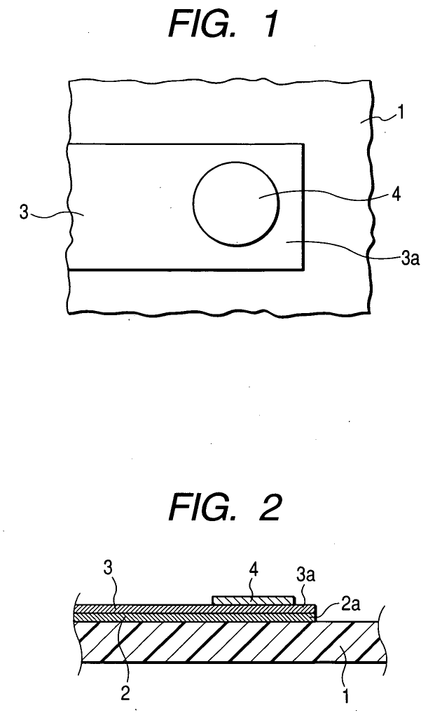

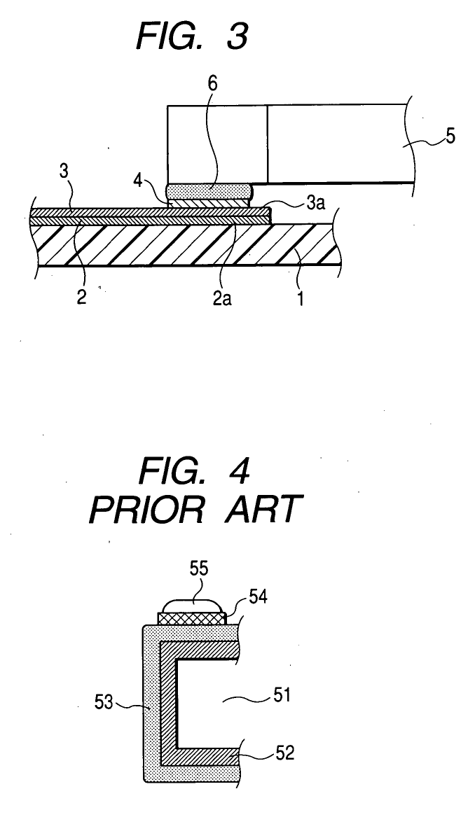

Drawings illustrating a connection structure of a wiring board according to the invention will be described. FIG. 1 is an enlarged plan view showing main parts of a connection terminal structure of a wiring board according to the invention. FIG. 2 is an enlarged cross-sectional view showing the main parts of the connection terminal structure of the wiring board according to the invention. FIG. 3 is an enlarged cross-sectional view showing a state in which an electronic component is connected to a connection terminal in the connection terminal structure of the wiring board according to the invention.

Hereinafter, the connection terminal structure of the wiring board according to the invention will be described with reference to FIGS. 1 to 3. A wiring board 1 is made of epoxy resin, ceramic, or alumina, and has a wiring pattern 2 made of a metallic material, such as copper, on the surface thereof. Furthermore, a first connecting terminal area portion 2a is formed on a part of the wiring pattern 2.

In addition, the wiring pattern 2 having the first terminal area portion 2a is formed in the form of a thick or thin film by, for example, plating or vapor deposition.

A metal layer 3 is formed on the wiring pattern 2 having the first terminal area portion 2a and forms an unsoldering surface. The metal layer 3 is made of nickel, chrome, titanium, or tantalum having poor solder wettability, or an alloy having these metallic materials as main ingredients, and has a second terminal area portion 3a formed on the first terminal area portion 2a.

Moreover, the metal layer 3 having the second terminal area portion 3a is formed in the form of a thick or thin film by, for example, plating or vapor deposition.

A third terminal area portion 4 for soldering-Clean connection is made of a noble metal having excellent solder wettability, such as gold or silver, and is formed on the second terminal area portion 3a. The third terminal area portion 4 has a smaller area than the second terminal area portion 3a so that the second terminal area portion 3a forming the unsoldering surface exists on the outer circumference of the third terminal area portion 4, thereby forming a soldering region. In this way, the connection terminal structure of the wiring board according to the invention is formed.

In the connection terminal structure of the wiring board according to the invention having the above-mentioned structure, as shown in FIG. 3, for example, an electronic component 5 or a motherboard (not shown) is disposed on the third terminal area portion 4 in a state in which cream solder is applied on the third terminal area portion 4 in advance. Then, these components are conveyed into a reflow furnace so that the electronic component 5 or the motherboard is soldered on the third terminal area portion 4 by melting the cream solder 6.

As described above, a connection terminal structure of a wiring board according to the invention includes a wiring board, a wiring pattern that is formed on the wiring board to have a first terminal area portion, a second terminal area portion that is made of a metallic material having poor solder wettability and is formed on the first terminal area portion, and a third terminal area portion for soldering-connection that is made of a noble metal having excellent solder wettability and is formed on the second terminal area portion. The third terminal area portion has a smaller area than the second terminal area portion so that the second terminal area portion forming an unsoldering surface exists on the outer circumference of the third terminal area portion. Since the third terminal area portion for soldering-connection, made of a noble metal, is formed on the second terminal area portion, which is an unsoldering surface, the third terminal area portion firmly adheres to the second terminal area portion serving as an unsoldering surface. Therefore, the third terminal area portion is not peeled off, and the third terminal area portion made of a noble metal has excellent solderability. For this reason, since preliminary soldering is not required, it is possible to obtain a connection terminal structure of a wiring board having excellent productivity.

Further, since the third terminal area portion is made of gold, silver, or an alloy having these materials as main ingredients, the third terminal area portion can not be peeled off, thereby improving productivity.

Furthermore, since the second terminal area portion is made of nickel, chrome, titanium, tantalum, or an alloy having these materials as main ingredients, it is possible to reliably form the unsoldering surface.

In addition, the wiring board is made of epoxy resin, ceramic, or alumina, and the first and second terminal area portions are formed on the wiring board in the form of a thick or thin film. Therefore, since the wiring pattern can be formed at high density, it is possible to miniaturize the wiring board.

1. A connection terminal structure of a wiring board comprising:
a wiring board;
a wiring pattern that is formed on the wiring board to have a first terminal area portion;
a second terminal area portion that is made of a metallic material having poor solder wettability and is formed on the first terminal area portion; and
a third terminal area portion for soldering-connection that is made of a noble metal having excellent solder wettability and is formed on the second terminal area portion;
wherein the third terminal area portion has a smaller area than the second terminal area portion so that the second terminal area portion forming an unsoldering surface exists on the outer circumference of the third terminal area portion.

2. The connection terminal structure of the wiring board according to claim 1,
wherein the third terminal area portion is made of gold, silver, or an alloy having these materials as main ingredients.

3. The connection terminal structure of the wiring board according to claim 1,
wherein the second terminal area portion is made of nickel, chrome, titanium, tantalum, or an alloy having these materials as main ingredients.

4. The connection terminal structure of the wiring board according to claim 1,
wherein the wiring board is made of epoxy resin, ceramic, or alumina, and the first and second terminal area portions are formed on the wiring board in the form of a thick or thin film.
